(19) United States
(12) Patent Application Publication
(10) Pub. No.: US 2021/0030162 A1
(43) Pub. Date: Feb. 4, 2021

(54) Iron Bed

(71) Applicant: Michael Stephen Medina, Littleton, CO (US)

(72) Inventor: Michael Stephen Medina, Littleton, CO (US)

(21) Appl. No.: 16/690,856

(22) Filed: Nov. 21, 2019

Related U.S. Application Data
(63) Continuation of application No. 16/571,144, now abandoned.
Application No. 16/571,144 is a continuation of application No. 16/526,510, filed on Jul. 30, 2019, now abandoned.

(51) Int. Cl. A47C 19/02

(52) U.S. Cl. CPC A47C 19/025; F16B 12/56; A47C 19/022

(57) ABSTRACT

This structurally engineered steel canopy bed frame provides another layer of protection to people living in earthquake prone areas to better protect themselves against falling debris-and is rated to withstand 39,000 pounds at each of the four vertical posts. This durable powder coated (more resistant to chipping, scratching and fading) bed frame comes in most twin to California King and custom mattress sizes with no box springs needed-and there are no moving parts.

### TECHNICAL FIELD

The present invention relates to improvements on bed frame designs by manufacturing them from steel with enough strength to withstand falling debris.

### BACKGROUND ART

The present invention generally relates to improvements in a bed frame, and more importantly an earthquake-related bed frame. Most bed designs are not strong enough to hold falling debris or to provide stability during swaying caused by an earthquake. There are many earthquake-related beds, with different designs and strength, unlike this one.

### SUMMARY OF THE INVENTION

This structurally engineered steel bed frame provides another layer of protection to people living in earthquake prone areas to better protect themselves against falling debris (rated to withstand 39,000 pounds at each post). This powder coated (stronger, more resistant to chipping, scratching and fading because of the thermal bonding process, which doesn't emit VOC's like paint) bed frame comes in most mattress sizes (twin to California King). No box springs needed. There are no moving parts.

According to the present invention, the steel tubular structure which fits into the base and top corner sleeves along with bolts to secure the structure at several points is easy enough for two people to assemble and strong enough to support most falling debris.

### BRIEF DESCRIPTION OF THE DRAWINGS

The previously submitted drawings show a top view of the canopy, side view, end view and top view of the bed frame with dimensions, welds and locations of brackets and fasteners.

FIG. 1/14 Side view of canopy including baseplates, bedframe posts with brackets (for optional bedframe height), bedframe tubing, canopy corner sleeves, and canopy tubing.

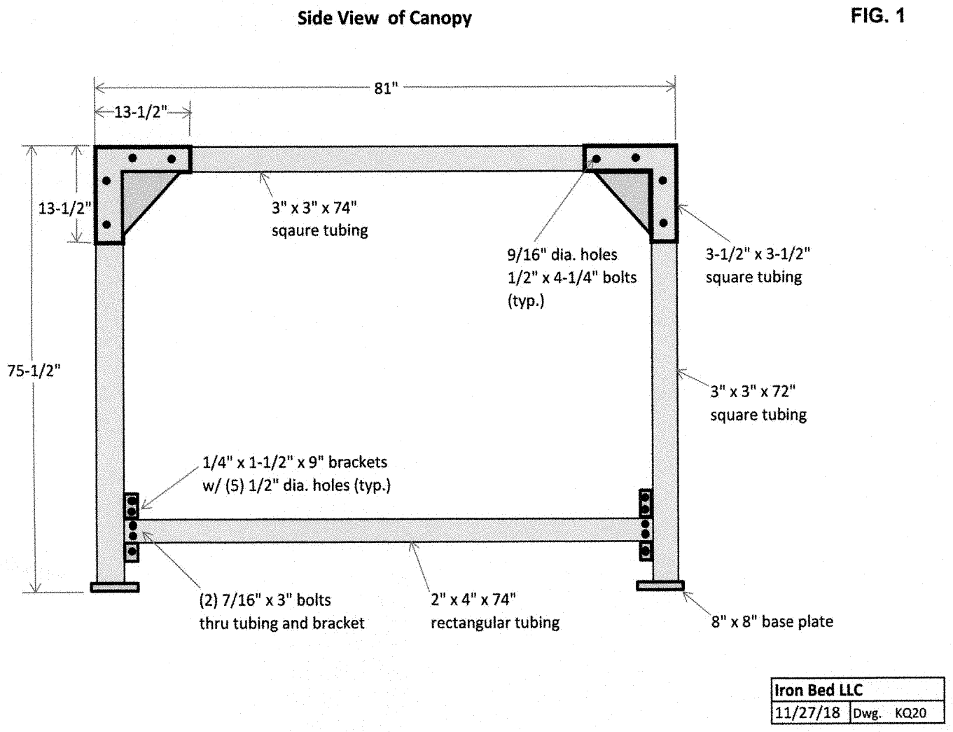

FIG. 2/14 End view of canopy including baseplates, bedframe tubing, corner sleeves, and canopy tubing.

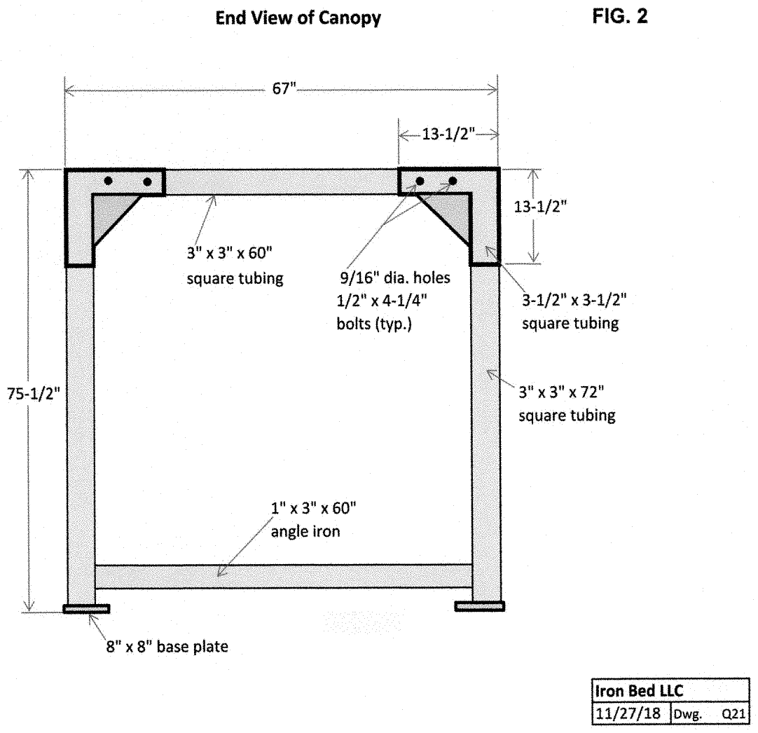

FIG. 3/14 Top view of bed frame including baseplates (which can be affixed to a foundation), bed frame posts with bedframe tubing and bedframe angle iron supports attached to bedframe brackets.

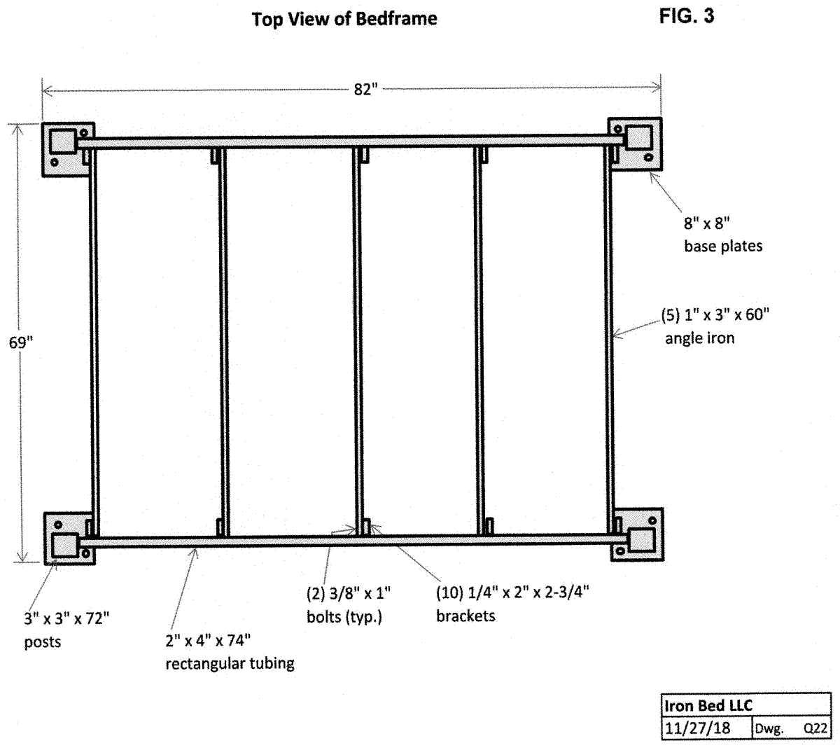

FIG. 4/14 Top view of canopy including canopy corner sleeves with gussets and square tubing attached to corner sleeves with angle iron attached for cross support.

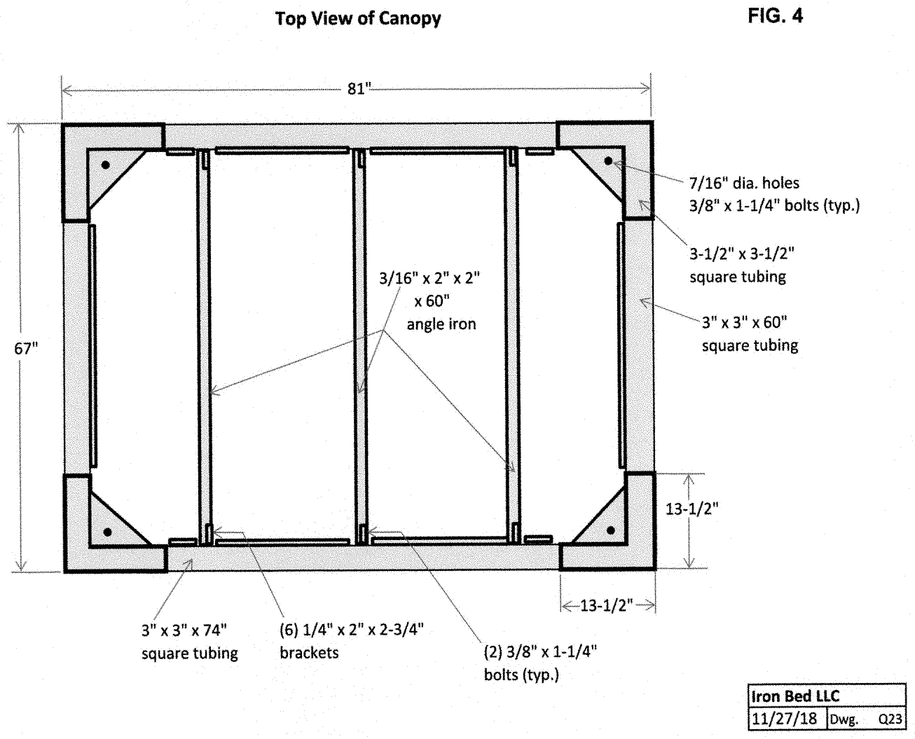

FIG. 5/14 Top view of canopy with perforated ½″ sheet metal that securely fastens to top canopy.

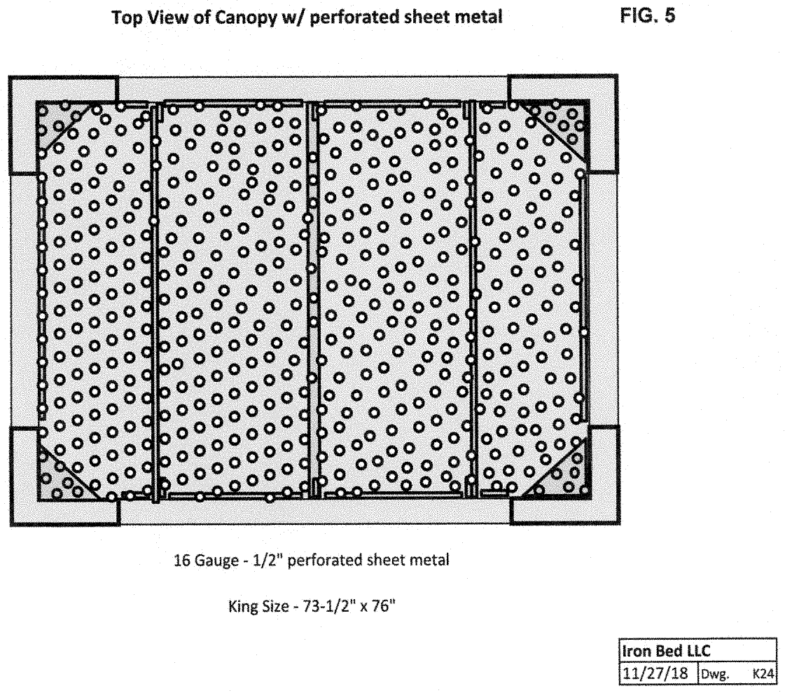

FIG. 6/14 Base plate with 3″×3″ post illustrating location of post welded to baseplate and location of (2) 9/16″ holes for anchor supports. Enlarged illustration of bedframe bracket with dimensions of holes for attachment of bedframe tubing. Illustration of 3″×3″ post shows location of 9″ bracket and above (2) 9/16″ holes for corner sleeve attachment.

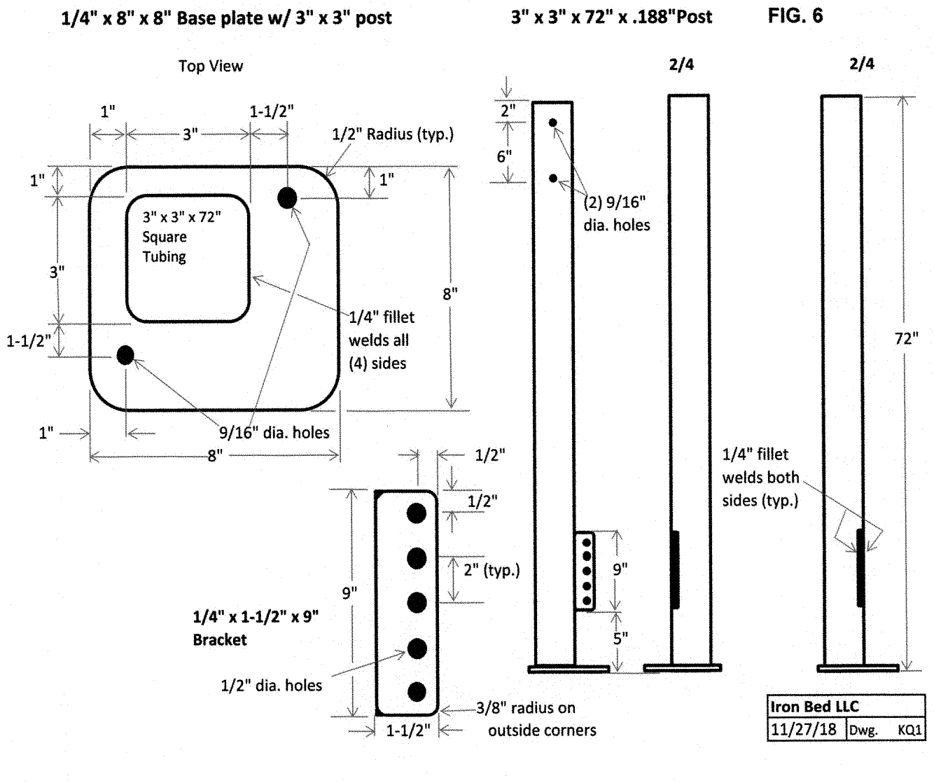

FIG. 7/14 ½″×9″×9″ gusset showing dimensions of bracket and size.

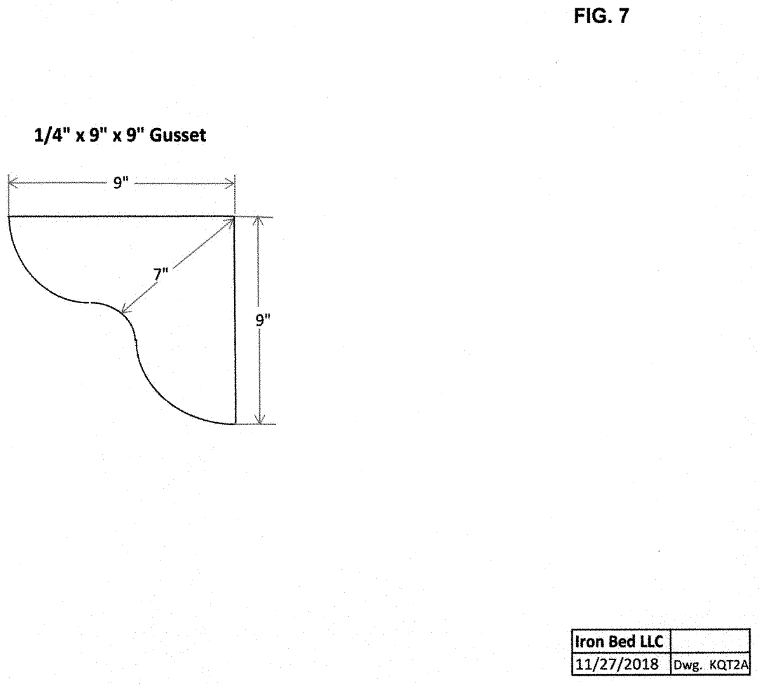

FIG. 8/14 Corner sleeves illustrating location of gusset, with size and dimensions of welds and drilled holes.

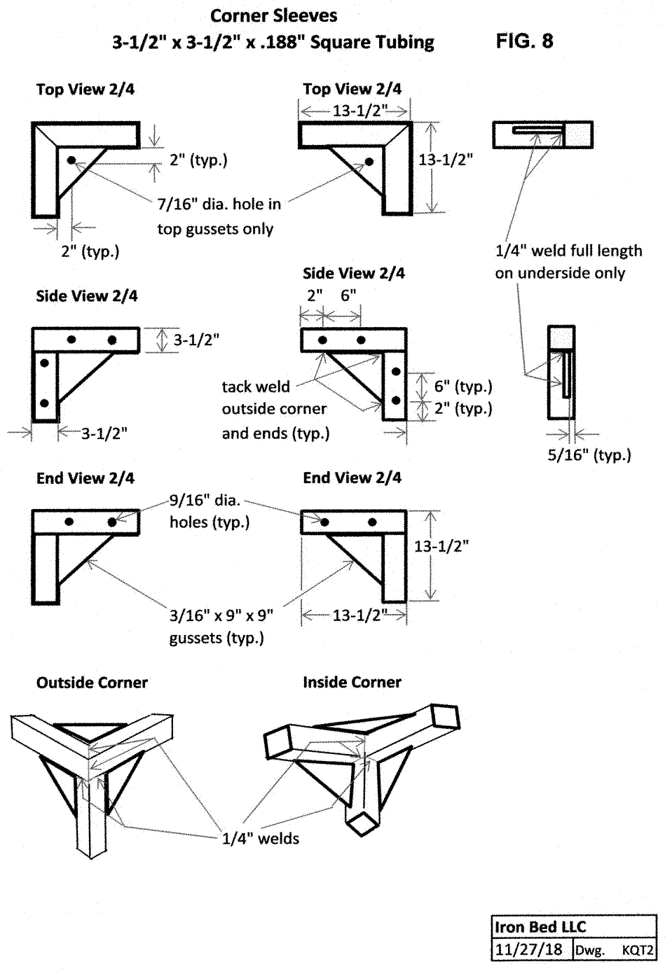

FIG. 9/14 3″×3″×74″×0.188″ square tubing illustrating flange location, dimensions and size and length of welds. Drawing also includes size and dimensions of drilled holes for corner sleeve attachment.

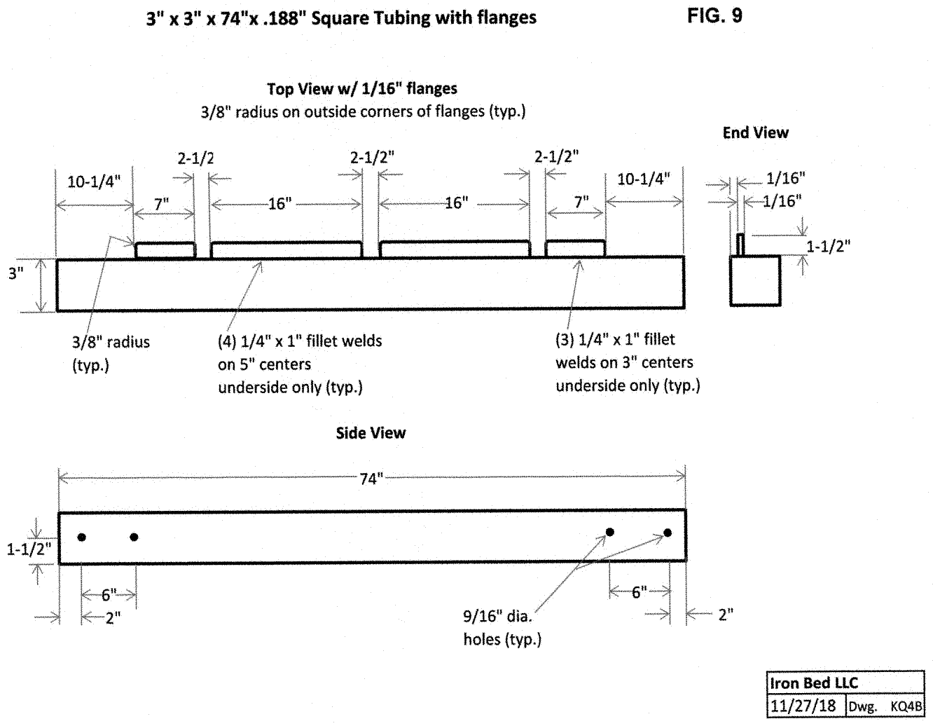

FIG. 10/14 3″×3″×74″×0.188″ square tubing illustrating location and dimensions of brackets, welds and drilled holes for attachment of the canopy angle iron.

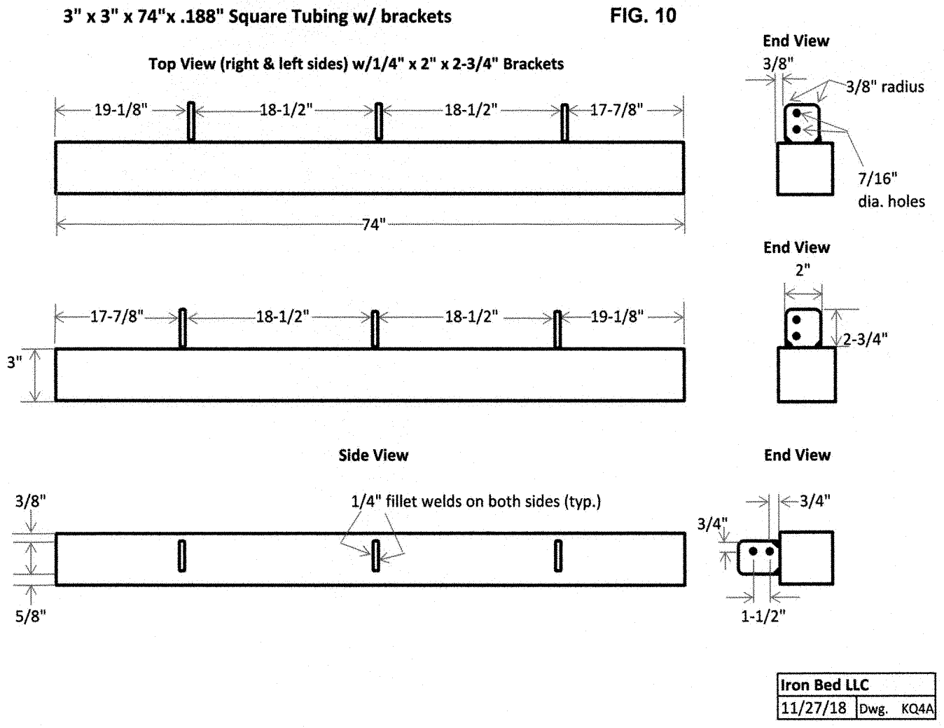

FIG. 11/14 3″×3″×60″×0.188″ square tubing illustrating flange location and dimensions including size and dimensions of welds and drilled holes.

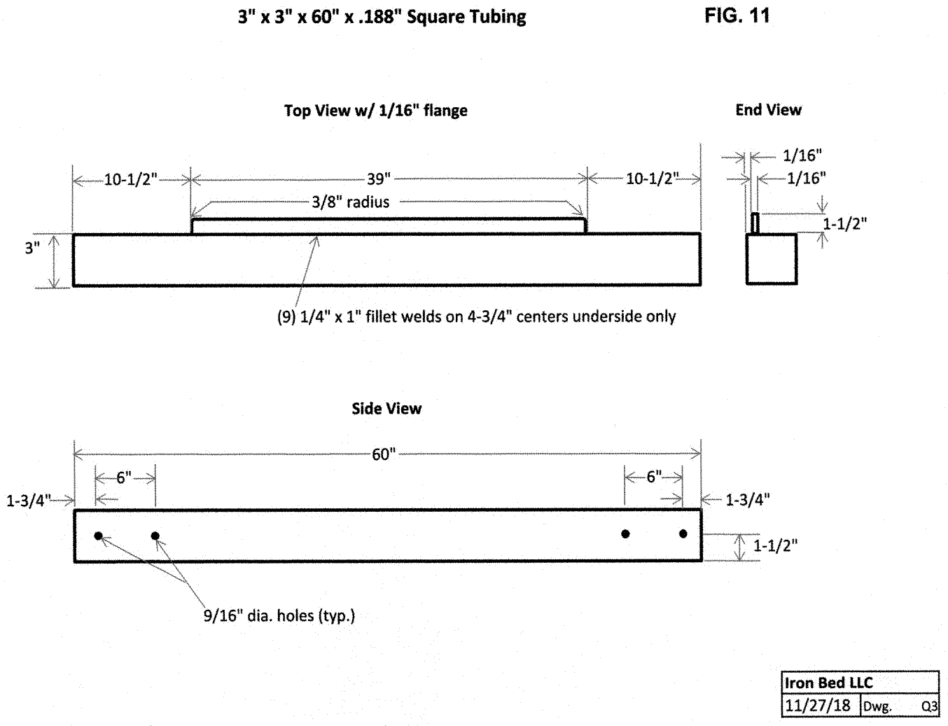

FIG. 12/14 2″×4″×74″×0.188″ rectangular tubing illustrating location and dimensions of brackets for bedframe angle iron supports including size of welds and size and dimensions of drilled holes for brackets and post supports.

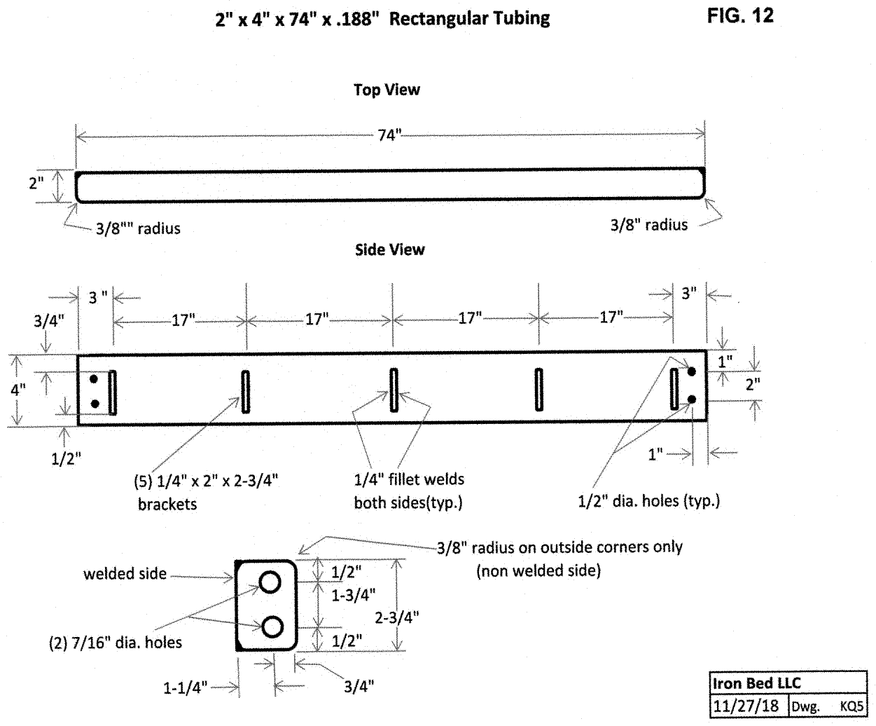

FIG. 13/14 3/16″×2″×2″×60″ angle iron illustrating location and dimensions of drilled holes.

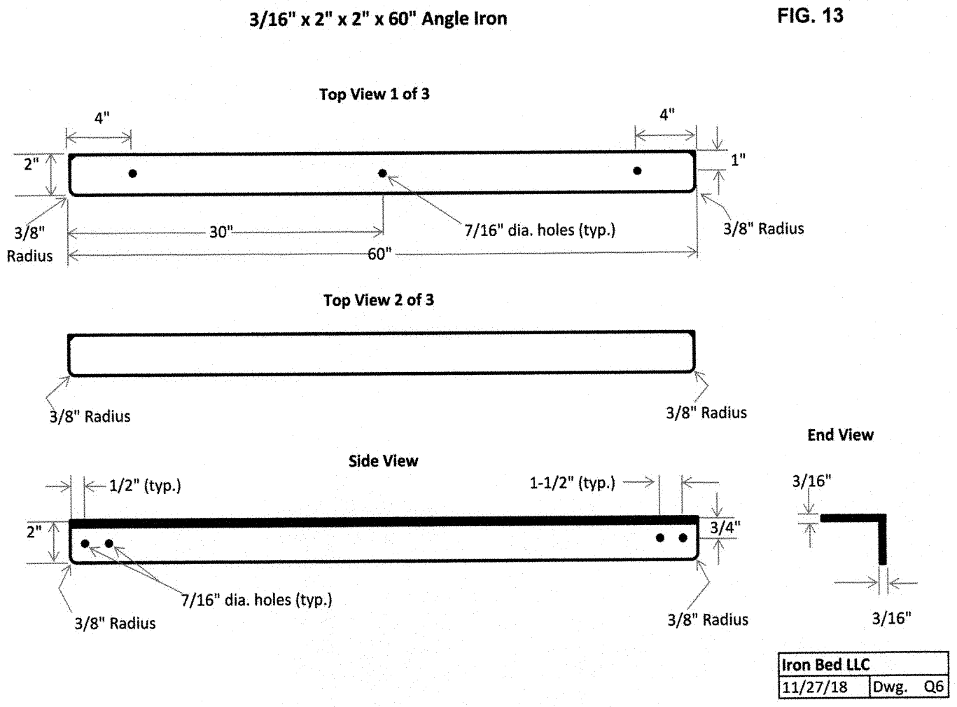

FIG. 14/14 1/16″×1″×3″×60″ angle iron illustrating location and dimensions of drilled holes.

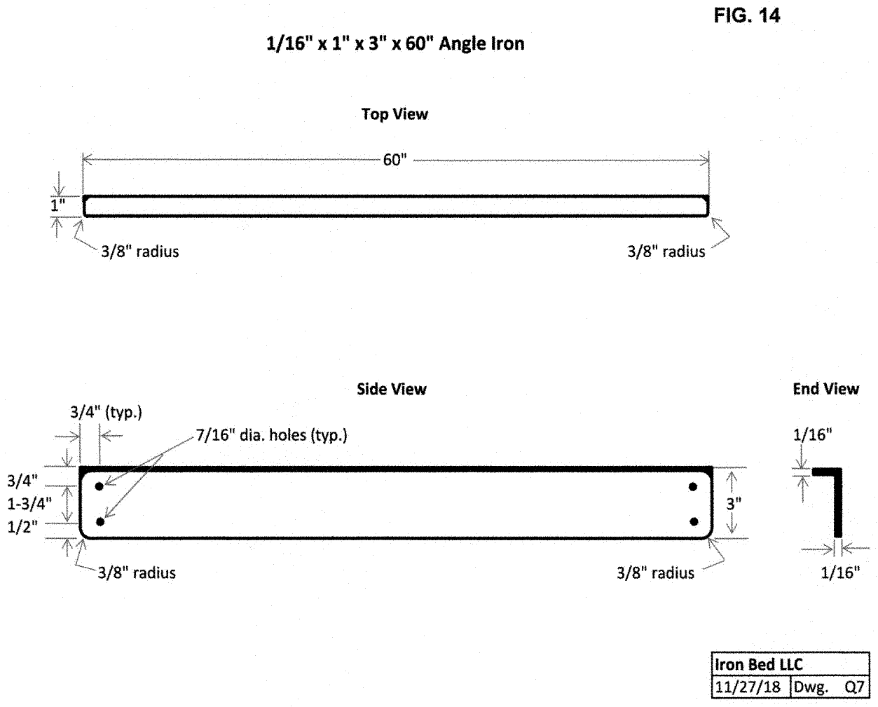

### DETAILED DESCRIPTION OF PREFERRED EMBODIMENTS

The structurally engineered canopy bed frame is comprised of (4) corner sleeves at the top corners of the canopy, (2) horizontal beams that make up the top sides, (1) horizontal beam at the head of the canopy and (1) horizontal beams at the foot of the canopy, (3) angle iron connecting the two sides of the canopy and (4) vertical posts with mattress frame attached to the bottom post brackets and 4 base plates with bolt holes to anchor the bedframe to the floor for extra stability. A set of metal perf sheets are also affixed to the top of the bed frame to catch and protect against potential falling debris. Instead of box springs, it is recommended to use ½″ OSB on the lower bed frame.

1. The structurally engineered steel canopy bed frame is comprised of (4) corner sleeves at the top corners of the canopy, (2) horizontal beams that make up the top sides, (1) horizontal beam at the head of the canopy and (1) horizontal beam at the foot of the canopy, (3) angle iron connecting the two sides of the canopy, and (4) vertical posts with mattress frame attached to the bottom post brackets.

2. The (4) 3½″×3½″×3½″ corner sleeves referred to in claim 1 consist of a welded one piece assembly with (3) gussets on each corner to add extra strength and include bolt holes in the sleeves to secure the horizontal beams and the vertical posts.

3. The (2) 3″×3″ horizontal beams at the top sides of the canopy referred to in claim 1, include brackets welded on the inner side and (3) 2″×2″ angle iron bolted to the brackets connecting the two sides together for further rigidity, and to support the ½″ perforated sheet metal.

4. The (2) 3″×3″ horizontal beams at the top sides of the canopy referred to in claim 3, and (1) 3″×3″ horizontal beam at the head of the canopy and (1) 3″×3″ horizontal beam at the foot of the canopy referred to in claim 1, have flanges welded on the inner sides to support the ½″ perforated sheet metal above the canopy

5. The ½″ perforated sheet metal referred to in claim 4 is bolted to the (4) corner sleeves and the middle angle iron.

6. The mattress frame referred to in claim 1 is made up of (2) 2″×4″ horizontal beams that form the sides of the mattress frame and include brackets welded on their inner side and have (5) 1″×3″ angle iron bolted to the brackets connecting the two sides together for further rigidity and to support the ½″ OSB board and mattress with the complete mattress frame then bolted to the vertical post brackets further supporting the lower section of the canopy frame.

7. The (4) 3″×3″ vertical posts referred to in claim 1 have base plates welded at the bottom of each post with bolt holes to anchor the bedframe to the floor for extra stability.

8. The canopy bedframe breaks down for ease in shipping as well as ease in assembly.
